(19) United States
(12) Patent Application Publication
(10) Pub. No.: US 2009/0083971 A1
(43) Pub. Date: Apr. 2, 2009

(54) Apparatus for assembling lenses

(75) Inventors: Ju Ho Kim, Yongin (KR); Du Young Jang, Suwon (KR); Jin Il Hong, Yongin (KR); Dong Jin Kim, Gwangmyung (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/007,588

(22) Filed: Jan. 11, 2008

(30) Foreign Application Priority Data
Sep. 28, 2007 (KR) 10-2007-98302

(51) Int. Cl. B23P 21/00

(52) U.S. Cl. 29/714

(57) ABSTRACT

There is provided an apparatus for assembling a plurality of lenses arranged on a tray according to a previously set order in a lens barrel, the apparatus including: a detector detecting a decenter of each of the plurality of lenses, the decenter that is a difference between a center of an effective diameter and a center of an outer diameter; a controller controlling the assembling of the lenses by determining a direction of the assembling the plurality of lenses according to the detected decenter of the each of the plurality of lenses; and an assembler sequentially assembling the plurality of lenses in the lens barrel according to a control of the controller.

### CROSS-REFERENCE TO RELATED APPLICATIONS

This application claims the priority of Korean Patent Application No. 2007-0098302 filed on Sep. 28, 2007, in the Korean Intellectual Property Office, the disclosure of which is incorporated herein by reference.

### BACKGROUND OF THE INVENTION

1. Field of the Invention

The present invention relates to an apparatus for assembling lenses, and more particularly, to an apparatus for assembling lenses, in which decenters of the lenses are measured and the lenses are rotated to be assembled according to the measured decenters, thereby improving optical properties of the lenses.

2. Description of the Related Art

Recently, as a large number of mobile communication terminals are provided, to correspond to requirements of users, mobile communication terminals generally perform various functions in addition to a communication function.

There is a digital imaging function in various additional functions. Accordingly, a mobile communication terminal includes an imaging device.

In the imaging device, for mobile application, plastic lenses are generally used. To prevent such plastic lenses from moving in a radial direction in a barrel, a plurality of lenses are fitted into a barrel with radial interference.

On the other hand, a lens includes an effective surface where light incident from outside passes through, and a rib where light does not passes. Ideally, the effective surface should be located in the center of the lens. That is, a center of the rib outer diameter should be coincide with a center of the effective lens surface.

Plastic lenses are manufactured by injection molding. Due to manufacturing and fabrication errors of injection mold base, forming errors from injection molding and deformations during a cooling process, as shown in FIG. 1, are generated the lens decenter errors, which is the difference between the center of outer diameter of lens rib and the center of lens effective surface.

FIG. 1 is a diagram illustrating the case where a center of an effective diameter does not coincide with a center of an outer diameter of lens.

Referring to FIG. 1, according to the described errors or deformation, there is generated the case where a center of an effective diameter does not coincide with a center of an outer diameter of lens. A difference between the center of the effective diameter and the center of the outer diameter in the lens is defined as a decenter.

A lens having such the decenter causes deterioration of an image quality of a photographed image.

### SUMMARY OF THE INVENTION

An aspect of the present invention provides an apparatus for assembling lenses, in which decenters of the lenses are measured and the lenses are rotated to be assembled according to the measured decenters, thereby improving optical properties of the lenses.

According to an aspect of the present invention, there is provided an apparatus for assembling a plurality of lenses arranged on a tray according to a previously set order in a lens barrel, the apparatus including: a detector detecting a decenter of each of the plurality of lenses, the decenter that is a difference between a center of an effective diameter and a center of an outer diameter; a controller controlling the assembling of the lenses by determining a direction of the assembling the plurality of lenses according to the detected decenter of the each of the plurality of lenses; and an assembler sequentially assembling the plurality of lenses in the barrel according to a control of the controller.

The controller may compare a position of a decenter of a lens presently assembled in the barrel with a position of a decenter of a lens previously assembled in the barrel and may determine the direction of the assembling the lenses according to a data table where lens performance according to a rotation direction of the lens presently assembled is set.

The controller may determine the rotation direction of the lens to be horizontal, based on a gate-cut of the lens.

The detector may detect the decenter of the lens by imaging a shadow of the lens surface.

The apparatus may further include a light source emitting light to the lens, on a top surface of the tray.

The apparatus may further include a backlight unit emitting light on the lens, on a bottom surface of the tray.

The tray may be formed of a transparent material to enhance the detection of decenters by transmitting the light from the backlight unit to the lens.

The lens may have a groove formed along an outer line of the effective diameter and defining the shadow of the lens to be clear.

According to an exemplary embodiment of the present invention, a decenter of a lens is detected and the lens is rotated according to the detected decenter when assembling the lens, thereby improving optical properties of the assembled lens.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a case where a center of an effective diameter does not correspond to a center of an outer diameter in a lens;

FIG. 2 is a configuration diagram illustrating an apparatus for assembling lenses, according to an exemplary embodiment of the present invention;

FIG. 3 is a graph illustrating optical properties according to rotation angles of lenses;

FIG. 4A is a graph illustrating a deviation of optical properties of a lens assembled by a conventional apparatus for assembling lenses; and

FIG. 4B is a graph illustrating a deviation of optical properties of a lens assembled by the apparatus for assembling lenses, according to an exemplary embodiment of the present invention.

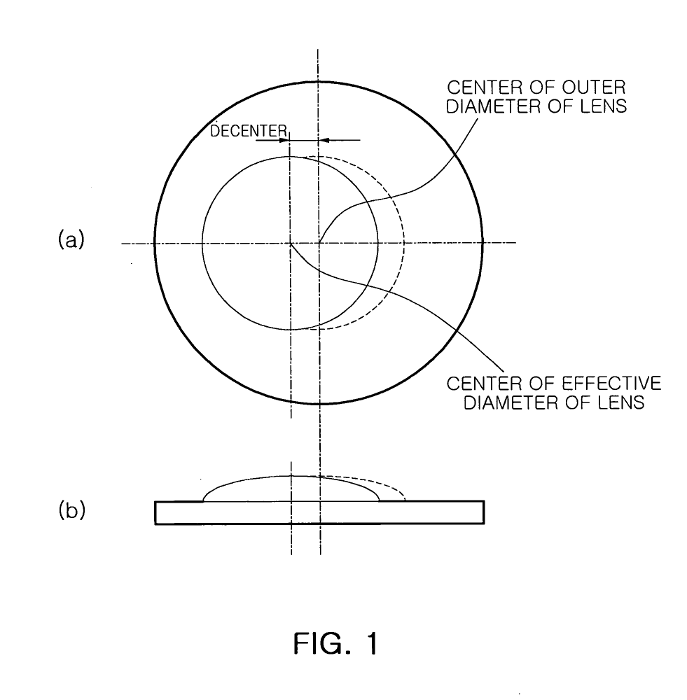

### DETAILED DESCRIPTION OF THE PREFERRED EMBODIMENT

Exemplary embodiments of the present invention will now be described in detail with reference to the accompanying drawings.

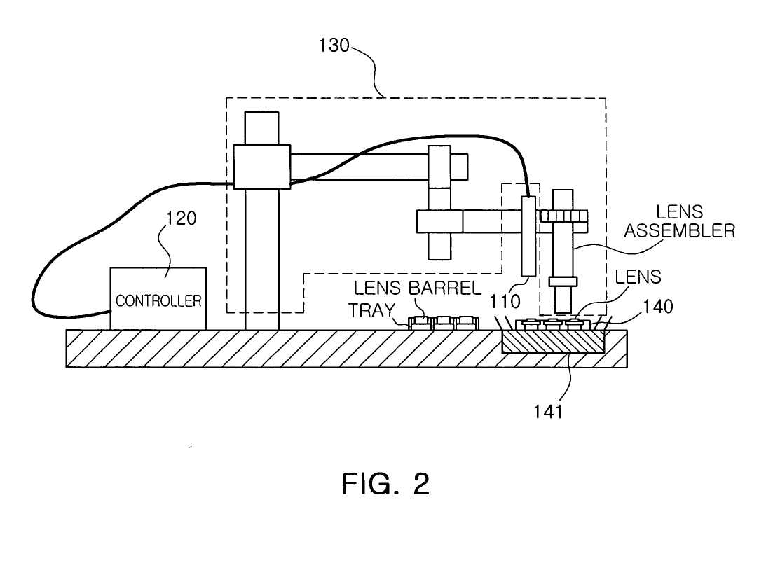

FIG. 2 is a configuration diagram illustrating an apparatus 100 for assembling lenses, according to an exemplary embodiment of the present invention.

Referring to FIG. 2, the apparatus 100 includes a detector 110, a controller 120, and an assembler 130.

The detector 110 photographs a shape of a lens on a tray 140 where a plurality of lenses are arranged, and detects a decenter that is an error between a center of an effective diameter and a center of an outer diameter in the lens.

The detector 110 detects the decenter of the lens from a shadow of the photographed shape of the lens. The lens may include a groove formed along an outer line of the effective diameter to allow the photographed shadow to be clear.

The controller 120 calculates a rotation direction of the lens according to the decenter of the lens, detected by the detector 110, and controls assembling the lens, performed by the assembler 130.

The rotation direction of the lens is calculated according to a data table previously set. The data table includes optical properties depending on a relationship between a rotation direction of a lens previously assembled and a rotation direction of a lens presently assembled in a lens barrel where lenses are assembled. As the optical properties, there is modulation transfer function (MTF) corresponding to a resolution.

Hereinafter, a decenter generated in a lens and setting a rotation direction of the lens by the controller 120 will be described in detail with reference to the drawings.

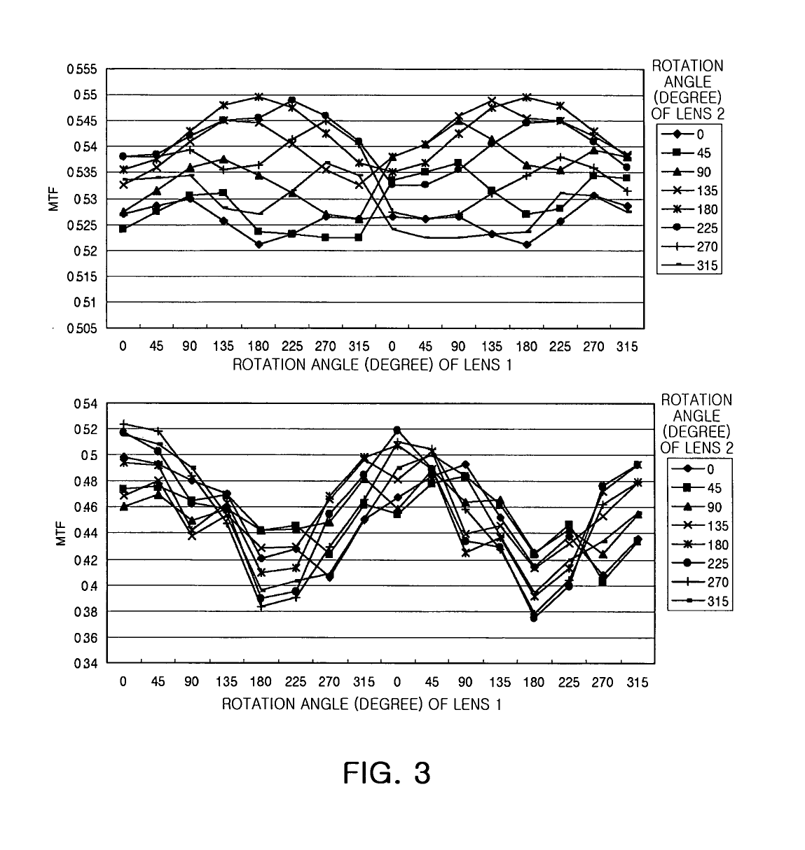

FIG. 3 is a graph illustrating optical properties according to rotation angles of lenses.

Referring to FIG. 3, in one or more lens barrels, two or more lenses such as lens 1 and lens 2 may be assembled. In this case, it may be assumed that the lens 1 is previously assembled in the barrel and the lens 2 is presently assembled in the barrel.

Generally, a lens can have more than two surfaces and these lens surfaces can be spherical or aspherical. And, these lens surfaces have decenter produced during manufacturing and fabrication of mold base, injection modling and cooling.

Decenters are present in each of the lens 1 and lens 2, and the controller 120 may rotate the lens 1 at any angle in the barrel. In this case, while rotating the lens 1 at any angle, it is easily performed based on a gate-cut of lens 1.

After that, the lens 2 assembled in the lens barrel may be also rotated according to a control of the controller 120. In this case, a rotation angle of the lens 2 may be set considering optical properties generated in a combination with the lens 1.

FIG. 3 illustrates MTF according to a kind and a rotation angle of the lens 1 and lens 2.

As described above, the rotation angle and the MTF of the lens 1 and lens 2 may be previously measured to form the data table included in the controller 120, and the controller 120 may set a rotation angle of an assembled lens according to the data table.

The assembler 130 sucks and transfers the plurality of lenses arranged in the lens tray 140 according to a preset sequence and sequentially assembles the plurality of lenses in the barrel according to the control of the controller 120.

The detector 110 of the apparatus 100 for assembling lenses photographs a shape of a lens and detects a decenter of the photographed lens from a shadow thereof as described above.

Accordingly, the apparatus 100 for assembling lenses may further include a light source 141 to allow the shadow of the lens to be clear.

The light source 141 is disposed on a top surface or a bottom surface of the lens tray 140 and emits light to the lens to allow the detector 110 to more accurately detect the decenter of the lens.

As shown in FIG. 2, the light source 141 may be formed of a backlight when being disposed on the bottom surface of the lens tray 140.

Optical properties of the apparatus 100 detecting a decenter of a lens and assembling the lens as described above will be compared with that of a conventional apparatus for assembling lenses with reference to the drawings.

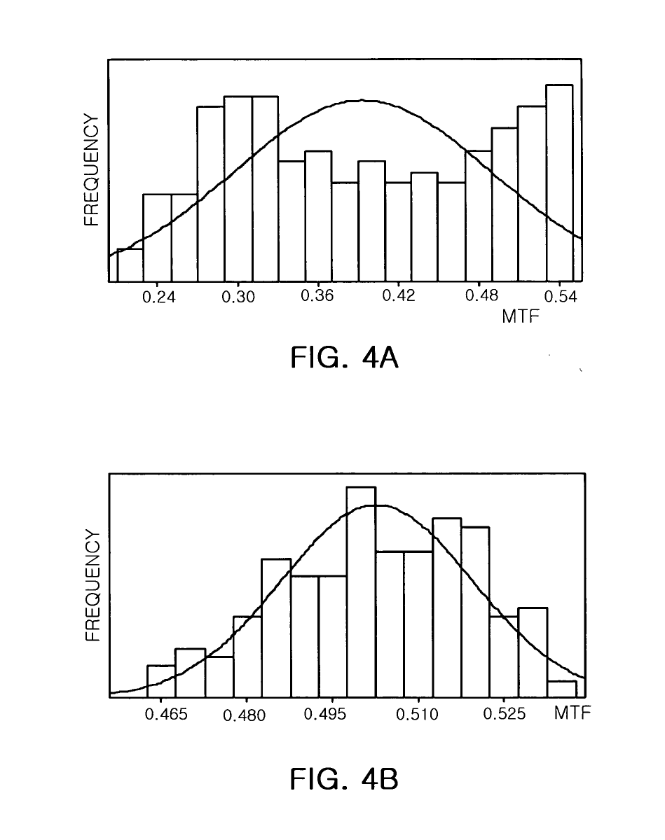

FIG. 4A is a graph illustrating a histogram of optical properties of a lens assembled by the conventional apparatus for assembling lenses, and FIG. 4B is a graph illustrating a histogram of optical properties of a lens assembled by the apparatus 100 for assembling lenses, according to an exemplary embodiment of the present invention.

Referring to FIG. 4A, the conventional apparatus assembles a lens with a random assembly angle regardless of a decenter of the lens. Accordingly, MTF average of the lens is about 0.393 and a standard deviation is 0.096.

On the other hand, referring to FIG. 4B, the apparatus 100 detects a decenter of a lens and rotates the lens while assembling the lens, thereby improving optical properties of the lens. Accordingly, MTF average of the lens is increased to about 0.503 and a standard deviation is decreased to 0.016.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for assembling a plurality of lenses arranged on a tray according to a previously set order in a lens barrel, the apparatus comprising:
a detector detecting a decenter of each of the plurality of lenses, the decenter that is a difference between a center of an effective diameter and a center of an outer diameter;
a controller controlling the assembling of the lenses by determining a direction of the assembling the plurality of lenses according to the detected decenter of the each of the plurality of lenses; and
an assembler sequentially rotating and assembling the plurality of lenses in the barrel according to a control of the controller.

2. The apparatus of claim 1, wherein the controller compares a position of a decenter of a lens presently assembled in the barrel with a position of a decenter of a lens previously assembled in the barrel and determines the direction of the assembling the lenses according to a data table where lens performance according to a rotation direction of the lens presently assembled is set.

3. The apparatus of claim 2, wherein the controller sets the rotation direction of the lens to be horizontal, based on a gate-cut of the lens.

4. The apparatus of claim 2, wherein the detector detects the decenter of the lens by imaging a shadow of the lens.

5. The apparatus of claim 4, further comprising a light source emitting light to the lens, on a top surface of the tray.

6. The apparatus of claim 4, further comprising a backlight unit emitting light on the lens, on a bottom surface of the tray.

7. The apparatus of claim 6, wherein the tray is formed of a transparent material transmitting the light from the backlight unit to the lens.

8. The apparatus of claim 4, wherein the lens has a groove formed along an outer line of the effective diameter and defining the shadow of the lens to be clear.
